(19) United States
(12) Patent Application Publication
(10) Pub. No.: US 2017/0181022 A1
(43) Pub. Date: Jun. 22, 2017

(54) METHOD AND APPARATUS FOR REPORTING CHANNEL STATE IN WIRELESS COMMUNICATION SYSTEM

(71) Applicant: LG ELECTRONICS INC., Seoul (KR)

(72) Inventors: Suckchel YANG, Seoul (KR); Hanbyul SEO, Seoul (KR); Seungmin LEE, Seoul (KR); Joonkui AHN, Seoul (KR)

(73) Assignee: LG ELECTRONICS INC., Seoul (KR)

(21) Appl. No.: 15/325,390

(22) PCT Filed: Jul. 28, 2015
(86) PCT No.: PCT/KR2015/007894

§ 371 Date: Jan. 10, 2017

Related U.S. Application Data
(60) Provisional application No. 62/029,581, filed on Jul. 28, 2014.

(51) Int. Cl. H04W 24/10

(52) U.S. Cl. CPC H04W 24/10; H04W 16/14

(57) ABSTRACT

The present invention relates to a wireless communication system and, specifically, to a method and an apparatus therefor, the method comprising the steps of: configuring a plurality of cells for communication with a base station; receiving CSI configuration information including period and offset information for periodic CSI reporting; and when periodic transmission timings of a plurality of CSIs collide in a subframe #n, transmitting only one CSI of the plurality of CSIs, wherein when cells corresponding to the plurality of CSIs are all licensed cells, the one CSI is first selected using priority according to the CSI reporting type, and when the cells corresponding o the plurality of CSIs include both licensed band cells and unlicensed band cells, the one CSI is selected from among CSIs corresponding to the unlicensed band cells, irrespective of the CSI reporting type.

### TECHNICAL FIELD

The present invention relates to a wireless communication system, and more particularly, to a method and apparatus for transmitting/receiving a wireless signal. The wireless communication system includes a CA-based (Carrier Aggregation-based) wireless communication system.

### BACKGROUND ART

Wireless communication systems have been widely deployed to provide various types of communication services including voice and data services. In general, a wireless communication system is a multiple access system that supports communication among multiple users by sharing available system resources (e.g. bandwidth, transmit power, etc.) among the multiple users. The multiple access system may adopt a multiple access scheme such as code division multiple access (CDMA), frequency division multiple access (FDMA), time division multiple access (TDMA), orthogonal frequency division multiple access (OFDMA), or single carrier frequency division multiple access (SC-FDMA).

### DISCLOSURE OF THE INVENTION

### Technical Task

An object of the present invention is to provide a method of efficiently performing channel state reporting and an apparatus therefor.

Technical tasks obtainable from the present invention are non-limited by the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a method of reporting a channel state, which is reported by a user equipment in a wireless communication system, includes the steps of setting a plurality of cells for performing communication with a base station, receiving CSI configuration information on each cell from the base station, wherein the CSI configuration information includes a period for periodic CSI reporting and offset information, and if periodic transmission timings of a plurality of CSIs collide with each other in a subframe #n, transmitting one CSI only among a plurality of the CSIs. In this case, if cells corresponding to a plurality of the CSIs correspond to all licensed band cells, the one CSI is firstly selected using a priority according to a CSI reporting type. If the cells corresponding to a plurality of the CSIs include both a licensed band cell and an unlicensed band cell, the one CSI is selected from CSI corresponding to the unlicensed band cell irrespective of the CSI reporting type.

To further achieve these and other advantages and in accordance with the purpose of the present invention, according to a different embodiment, a user equipment configured to report a channel state in a wireless communication system includes an RF (radio frequency) module and a processor, the processor configured to set a plurality of cells for performing communication with a base station, the processor configured to receive CSI configuration information on each cell from the base station, wherein the CSI configuration information includes a period for periodic CSI reporting and offset information, the processor, if periodic transmission timings of a plurality of CSIs collide with each other in a subframe #n, configured to transmit one CSI only among a plurality of the CSIs. In this case, if cells corresponding to a plurality of the CSIs correspond to all licensed band cells, the one CSI is firstly selected using a priority according to a CSI reporting type. And, if the cells corresponding to a plurality of the CSIs include both a licensed band cell and an unlicensed band cell, the one CSI is selected from CSI corresponding to the unlicensed band cell irrespective of the CSI reporting type.

Preferably, if the cells corresponding to a plurality of the CSIs include a plurality of unlicensed band cells, the one CSI can be selected from a plurality of CSIs corresponding to a plurality of the unlicensed band cells using a priority according to the CSI reporting type.

Preferably, if the one CSI is included in the licensed band cell, transmission of the one CSI does not involve transmission of cell indication information on the licensed band cell. If the one CSI is included in the unlicensed band cell, the transmission of the one CSI may involve transmission of cell indication information on the unlicensed band cell.

Preferably, the one CSI can be transmitted on PUCCH (physical uplink control channel) of the licensed band cell.

### Advantageous Effects

According to the present invention, it is able to efficiently perform channel state reporting in a wireless communication system.

Effects obtainable from the present invention are non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates physical channels used in 3GPP LTE(-A) and a signal transmission method using the same.

FIG. 2 illustrates a radio frame structure.

FIG. 3 illustrates a resource grid of a downlink slot.

FIG. 4 illustrates a downlink subframe structure.

FIG. 5 illustrates an example of Enhanced Physical Downlink Control Channel (EPDCCH).

FIG. 6 illustrates the structure of an uplink subframe.

FIG. 7 illustrates an example of a concept for channel status information generation and transmission.

FIG. 8 illustrates an example of a CQI report scheme of LTE according to a related art.

FIG. 9 is a diagram for one example of a method for processing UL-SCH data and control information.

FIG. 10 illustrates a carrier aggregation (CA)-based wireless communication system.

FIG. 11 illustrates a cross-carrier scheduling.

FIG. 12 illustrates carrier aggregation of a licensed band and an unlicensed band.

FIGS. 13 and 14 illustrate a method of occupying a resource in an unlicensed band.

FIG. 15 illustrates a method of performing CSI reporting in a legacy CA situation.

FIG. 16 illustrates a method of reporting CSI according to one embodiment of the present invention.

FIG. 17 illustrates a base station and a user equipment applicable to an embodiment of the present invention.

### BEST MODE

### Mode for Invention

Embodiments of the present invention are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is a part of Evolved UMTS (E-UMTS) using E-UTRA, employing OFDMA for downlink and SC-FDMA for uplink. LTE-Advanced (LTE-A) evolves from 3GPP LTE.

While the following description is given, centering on 3GPP LTE/LTE-A for clarity, this is purely exemplary and thus should not be construed as limiting the present invention. It should be noted that specific terms disclosed in the present invention are proposed for convenience of description and better understanding of the present invention, and the use of these specific terms may be changed to other formats within the technical scope or spirit of the present invention.

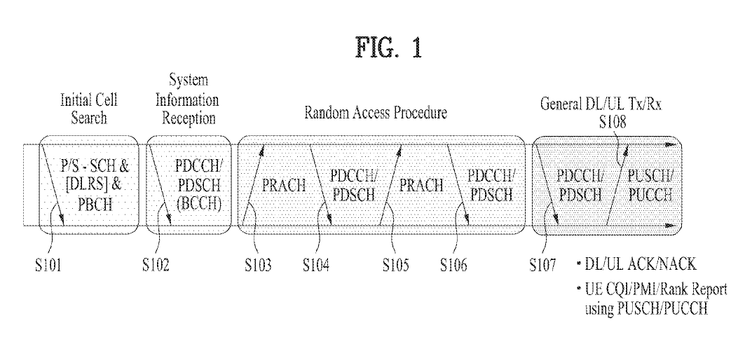

FIG. 1 illustrates physical channels used in 3GPP LTE(-A) and a signal transmission method using the same.

When powered on or when a UE initially enters a cell, the UE performs initial cell search involving synchronization with a BS in step S101. For initial cell search, the UE synchronizes with the BS and acquire information such as a cell Identifier (ID) by receiving a primary synchronization channel (P-SCH) and a secondary synchronization channel (S-SCH) from the BS. Then the UE may receive broadcast information from the cell on a physical broadcast channel (PBCH). In the mean time, the UE may check a downlink channel status by receiving a downlink reference signal (DL RS) during initial cell search.

After initial cell search, the UE may acquire more specific system information by receiving a physical downlink control channel (PDCCH) and receiving a physical downlink shared channel (PDSCH) based on information of the PDCCH in step S102.

The UE may perform a random access procedure to access the BS in steps S103 to S106. For random access, the UE may transmit a preamble to the BS on a physical random access channel (PRACH) (S103) and receive a response message for preamble on a PDCCH and a PDSCH corresponding to the PDCCH (S104). In the case of contention-based random access, the UE may perform a contention resolution procedure by further transmitting the PRACH (S105) and receiving a PDCCH and a PDSCH corresponding to the PDCCH (S106).

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

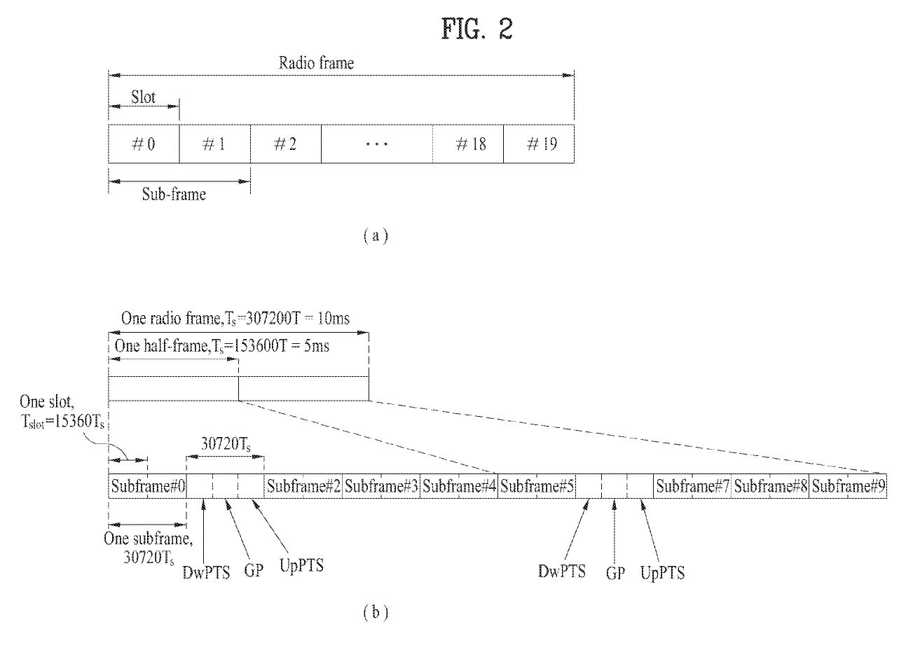

FIG. 2 illustrates a radio frame structure. Uplink/downlink data packet transmission is performed on a subframe-by-subframe basis. A subframe is defined as a predetermined time interval including a plurality of symbols. 3GPP LTE supports a type-1 radio frame structure applicable to frequency division duplex (FDD) and a type-2 radio frame structure applicable to time division duplex (TDD).

FIG. 2(a) illustrates a type-1 radio frame structure. A downlink subframe includes 10 subframes each of which includes 2 slots in the time domain. A time for transmitting a subframe is defined as a transmission time interval (TTI). For example, each subframe has a duration of 1 ms and each slot has a duration of 0.5 ms. A slot includes a plurality of OFDM symbols in the time domain and includes a plurality of resource blocks (RBs) in the frequency domain. Since downlink uses OFDM in 3GPP LTE, an OFDM symbol represents a symbol period. The OFDM symbol may be called an SC-FDMA symbol or symbol period. An RB as a resource allocation unit may include a plurality of consecutive subcarriers in one slot.

The number of OFDM symbols included in one slot may depend on cyclic prefix (CP) configuration. CPs include an extended CP and a normal CP. When an OFDM symbol is configured with the normal CP, for example, the number of OFDM symbols included in one slot may be 7. When an OFDM symbol is configured with the extended CP, the length of one OFDM symbol increases, and thus the number of OFDM symbols included in one slot is smaller than that in case of the normal CP. In case of the extended CP, the number of OFDM symbols allocated to one slot may be 6. When a channel state is unstable, such as a case in which a UE moves at a high speed, the extended CP can be used to reduce inter-symbol interference.

When the normal CP is used, one subframe includes 14 OFDM symbols since one slot has 7 OFDM symbols. The first three OFDM symbols at most in each subframe can be allocated to a PDCCH and the remaming OFDM symbols can be allocated to a PDSCH.

FIG. 2(b) illustrates a type-2 radio frame structure. The type-2 radio frame includes 2 half frames. Each half frame includes 4(5) normal subframes and 10 special subframes. The normal subframes are used for uplink or downlink according to UL-DL configuration. A subframe is composed of 2 slots.

Table 1 shows subframe configurations in a radio frame according to UL-DL configurations.

TABLE 1

| Uplink- | Downlink- | | | | | | | | | | |
|---|---|---|---|---|---|---|---|---|---|---|---|
| downlink | to-Uplink | | | | | | | | | | |
| config- | Switch point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes DwPTS (Downlink Pilot TimeSlot), GP (Guard Period), and UpPTS (Uplink Pilot TimeSlot). DwPTS is used for initial cell search, synchronization or channel estimation in a UE and UpPTS is used for channel estimation in a BS and uplink transmission synchronization in a UE. The GP eliminates UL interference caused by multi-path delay of a DL signal between a UL and a DL.

The radio frame structure is merely exemplary and the number of subframes included in the radio frame, the number of slots included in a subframe, and the number of symbols included in a slot can be vary.

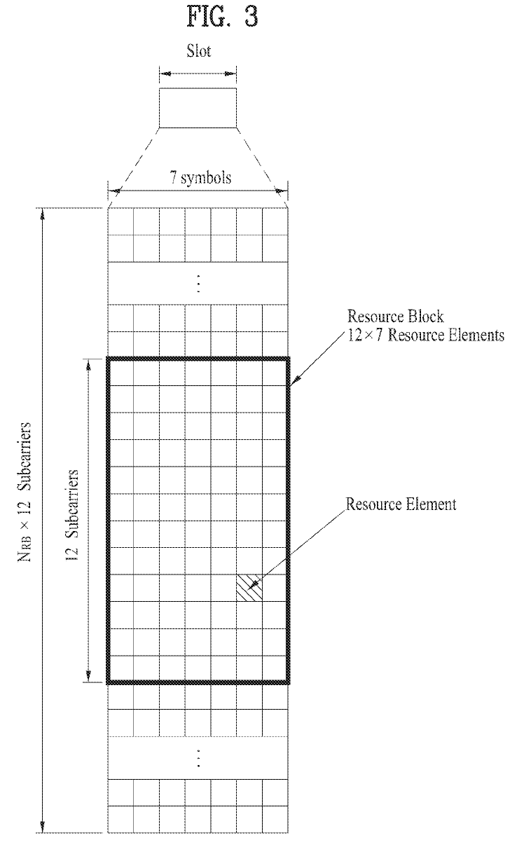

FIG. 3 illustrates a resource grid of a downlink slot.

Referring to FIG. 3, a downlink slot includes a plurality of OFDM symbols in the time domain. While one downlink slot may include 7 OFDM symbols and one resource block (RB) may include 12 subcarriers in the frequency domain in the figure, the present invention is not limited thereto. Each element on the resource grid is referred to as a resource element (RE). One RB includes 12×7 REs. The number NRB of RBs included in the downlink slot depends on a downlink transmit bandwidth. The structure of an uplink slot may be same as that of the downlink slot.

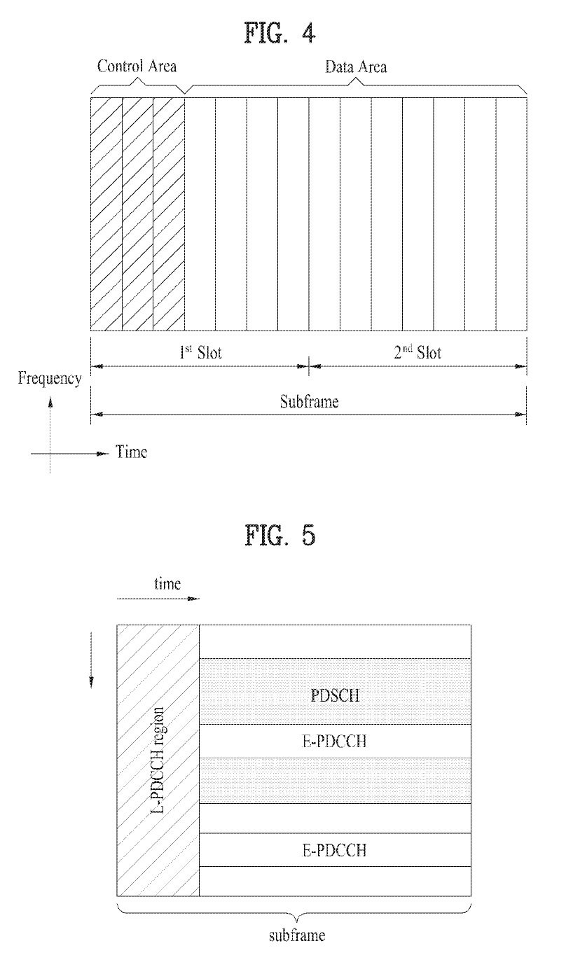

FIG. 4 illustrates a downlink subframe structure.

Referring to FIG. 4, a maximum of three (four) OFDM symbols located in a front portion of a first slot within a subframe correspond to a control region to which a control channel is allocated. The remaming OFDM symbols correspond to a data region to which a physical downlink shared chancel (PDSCH) is allocated. A basic resource unit of the data region is an RB. Examples of downlink control channels used in LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative-acknowledgment (NACK) signal. Control information transmitted through the PDCCH is referred to as downlink control information (DCI). The DCI includes uplink or downlink scheduling information or an uplink transmit power control command for an arbitrary UE group.

Control information transmitted through the PDCCH is referred to as downlink control information (DCI). Formats 0, 3, 3A and 4 for uplink and formats 1, 1A, 1B, 1C, 1D, 2, 2A, 2B and 2C for downlink are defined as DCI formats. Information field type, the number of information fields, the number of bits of each information field, etc. depend on DIC format. For example, the DCI formats selectively include information such as hopping flag, RB assignment, MCS (Modulation Coding Scheme), RV (Redundancy Version), NDI (New Data Indicator), TPC (Transmit Power Control), HARQ process number, PMI (Precoding Matrix Indicator) confirmation as necessary. Accordingly, the size of control information matched to a DCI format depends on the DCI format. A arbitrary DCI format may be used to transmit two or more types of control information. For example, DIC formats 0/1A is used to carry DCI format 0 or DIC format 1, which are discriminated from each other using a flag field.

A PDCCH may carry a transport format and a resource allocation of a downlink shared channel (DL-SCH), resource allocation information of an uplink shared channel (UL-SCH), paging information on a paging channel (PCH), system information on the DL-SCH, information on resource allocation of an upper-layer control message such as a random access response transmitted on the PDSCH, a set of Tx power control commands on individual UEs within an arbitrary UE group, a Tx power control command, information on activation of a voice over IP (VoIP), etc. A plurality of PDCCHs can be transmitted within a control region. The UE can monitor the plurality of PDCCHs. The PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). A format of the PDCCH and the number of bits of the available PDCCH are determined by the number of CCEs. The BS determines a PDCCH format according to DCI to be transmitted to the UE, and attaches a cyclic redundancy check (CRC) to control information. The CRC is masked with a unique identifier (referred to as a radio network temporary identifier (RNTI)) according to an owner or usage of the PDCCH. If the PDCCH is for a specific UE, a unique identifier (e.g., cell-RNTI (C-RNTI)) of the UE may be masked to the CRC. Alternatively, if the PDCCH is for a paging message, a paging identifier (e.g., paging-RNTI (P-RNTI)) may be masked to the CRC. If the PDCCH is for system information (more specifically, a system information block (SIB)), a system information RNTI (SI-RNTI) may be masked to the CRC. When the PDCCH is for a random access response, a random access-RNTI (RA-RNTI) may be masked to the CRC.

The PDCCH carries a message known as DCI which includes resource assignment information and other control information for a UE or UE group. In general, a plurality of PDCCHs can be transmitted in a subframe. Each PDCCH is transmitted using one or more CCEs. Each CCE corresponds to 9 sets of 4 REs. The 4 REs are referred to as an REG 4 QPSK symbols are mapped to one REG REs allocated to a reference signal are not included in an REG and thus the total number of REGs in OFDM symbols depends on presence or absence of a cell-specific reference signal. The concept of REG (i.e. group based mapping, each group including 4 REs) is used for other downlink control channels (PCFICH and PHICH). That is, REG is used as a basic resource unit of a control region. 4 PDCCH formats are supported as shown in Table 2.

TABLE 2

| | | | Number of |
|---|---|---|---|
| PDCCH format | Number of CCEs (n) | Number of REGs | PDCCH bits |
| 0 | 1 | 9 | 72 |
| 1 | 2 | 8 | 144 |
| 2 | 4 | 36 | 288 |
| 3 | 5 | 72 | 576 |

CCEs are sequentially numbered. To simplify a decoding process, transmission of a PDCCH having a format including n CCEs can be started using as many CCEs as a multiple of n. The number of CCEs used to transmit a specific PDCCH is determined by a BS according to channel condition. For example, if a PDCCH is for a UE having a high-quality downlink channel (e.g. a channel close to the BS), only one CCE can be used for PDCCH transmission. However, for a UE having a poor channel (e.g. a channel close to a cell edge), 8 CCEs can be used for PDCCH transmission in order to obtain sufficient robustness. In addition, a power level of the PDCCH can be controlled according to channel condition.

LTE defines CCE positions in a limited set in which PDCCHs can be positioned for each UE. CCE positions in a limited set that the UE needs to monitor in order to detect the PDCCH allocated thereto may be referred to as a search space (SS). In LTE, the SS has a size depending on PDCCH format. A UE-specific search space (USS) and a common search space (CSS) are separately defined. The USS is set per UE and the range of the CSS is signaled to all UEs. The USS and the CSS may overlap for a given UE. In the case of a considerably small SS with respect to a specific UE, when some CCEs positions are allocated in the SS, remaming CCEs are not present. Accordingly, the BS may not find CCE resources on which PDCCHs will be transmitted to available UEs within given subframes. To minimize the possibility that this blocking continues to the next subframe, a UE-specific hopping sequence is applied to the starting point of the USS.

Table 3 shows sizes of the CSS and USS.

TABLE 3

| PDCCH | Number of | Number of candidates in | Number of candidates in |
|---|---|---|---|
| format | CCEs (n) | common search space | dedicated search space |
| 0 | 1 | — | 6 |
| 1 | 2 | — | 6 |
| 2 | 4 | 4 | 2 |
| 3 | 8 | 2 | 2 |

To control computational load of blind decoding based on the number of blind decoding processes to an appropriate level, the UE is not required to simultaneously search for all defined DCI formats. In general, the UE searches for formats 0 and 1A at all times in the USS. Formats 0 and 1A have the same size and are discriminated from each other by a flag in a message. The UE may need to receive an additional format (e.g. format 1, 1B or 2 according to PDSCH transmission mode set by a BS). The UE searches for formats 1A and 1C in the CSS. Furthermore, the UE may be set to search for format 3 or 3A. Formats 3 and 3A have the same size as that of formats 0 and 1A and may be discriminated from each other by scrambling CRC with different (common) identifiers rather than a UE-specific identifier. PDSCH transmission schemes and information content of DCI formats according to transmission mode (TM) are arranged below.

Transmission Mode (TM)
Transmission mode 1: Transmission from a single base station antenna port
Transmission mode 2: Transmit diversity
Transmission mode 3: Open-loop spatial multiplexing
Transmission mode 4: Closed-loop spatial multiplexing
Transmission mode 5: Multi-user MIMO (Multiple Input Multiple Output)
Transmission mode 6: Closed-loop rank-1 precoding
Transmission mode 7: Single-antenna port (ports) transmission
Transmission mode 8: Double layer transmission (ports 7 and 8) or single-antenna port (port 7 or 8) transmission
Transmission mode 9: Transmission through up to 8 layers (ports 7 to 14) or single-antenna port (port 7 or 8) transmission

DCI Format
Format 0: Resource grants for PUSCH transmission
Format 1: Resource assignments for single codeword PDSCH transmission (transmission modes 1, 2 and 7)
Format 1A: Compact signaling of resource assignments for single codeword PDSCH (all modes)
Format 1B: Compact resource assignments for PDSCH using rank-1 closed loop precoding (mod 6)
Format 1C: Very compact resource assignments for PDSCH (e.g. paging/broadcast system information)
Format 1D: Compact resource assignments for PDSCH using multi-user MIMO (mode 5)
Format 2: Resource assignments for PDSCH for closed-loop MIMO operation (mode 4)
Format 2A: Resource assignments for PDSCH for open-loop MIMO operation (mode 3)
Format 3/3A: Power control commands for PUCCH and PUSCH with 2-bit/1-bit power adjustments

FIG. 5 illustrates an EPDCCH. The EPDCCH is a channel additionally introduced in LTE-A.

Referring to FIG. 5, a PDCCH (for convenience, legacy PDCCH or L-PDCCH) according to legacy LTE may be allocated to a control region (see FIG. 4) of a subframe. In the figure, the L-PDCCH region means a region to which a legacy PDCCH may be allocated. Meanwhile, a PDCCH may be further allocated to the data region (e.g., a resource region for a PDSCH). A PDCCH allocated to the data region is referred to as an E-PDCCH. As shown, control channel resources may be further acquired via the E-PDCCH to mitigate a scheduling restriction due to restricted control channel resources of the L-PDCCH region. Similarly to the L-PDCCH, the E-PDCCH carries DCI. For example, the E-PDCCH may carry downlink scheduling information and uplink scheduling information. For example, the UE may receive the E-PDCCH and receive data/control information via a PDSCH corresponding to the E-PDCCH. In addition, the UE may receive the E-PDCCH and transmit data/control information via a PUSCH corresponding to the E-PDCCH. The E-PDCCH/PDSCH may be allocated starting from a first OFDM symbol of the subframe, according to cell type. In this specification, the PDCCH includes both L-PDCCH and EPDCCH unless otherwise noted.

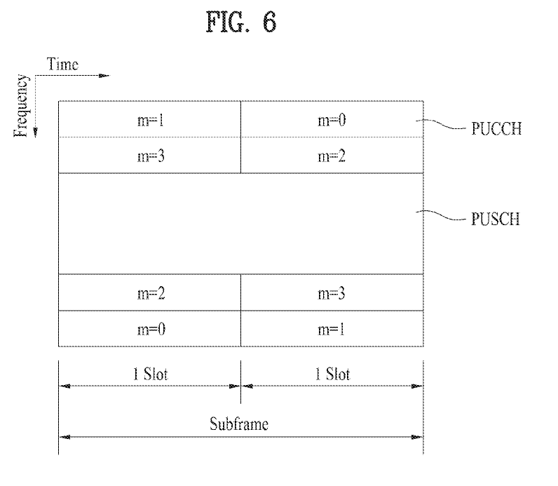

FIG. 6 illustrates an uplink subframe structure.

Referring to FIG. 6, an uplink subframe includes a plurality of (e.g. 2) slots. A slot may include different numbers of SC-FDMA symbols according to CP lengths. For example, a slot may include 7 SC-FDMA symbols in a normal CP case. The uplink subframe is divided into a control region and a data region in the frequency domain. The data region is allocated with a PUSCH and used to carry a data signal such as audio data. The control region is allocated a PUCCH and used to carry control information. The PUCCH includes an RB pair (e.g. m=0, 1, 2, 3) located at both ends of the data region in the frequency domain and hopped in a slot boundary. Control information includes HARQ ACK/NACK, CQI, PMI, RI, etc

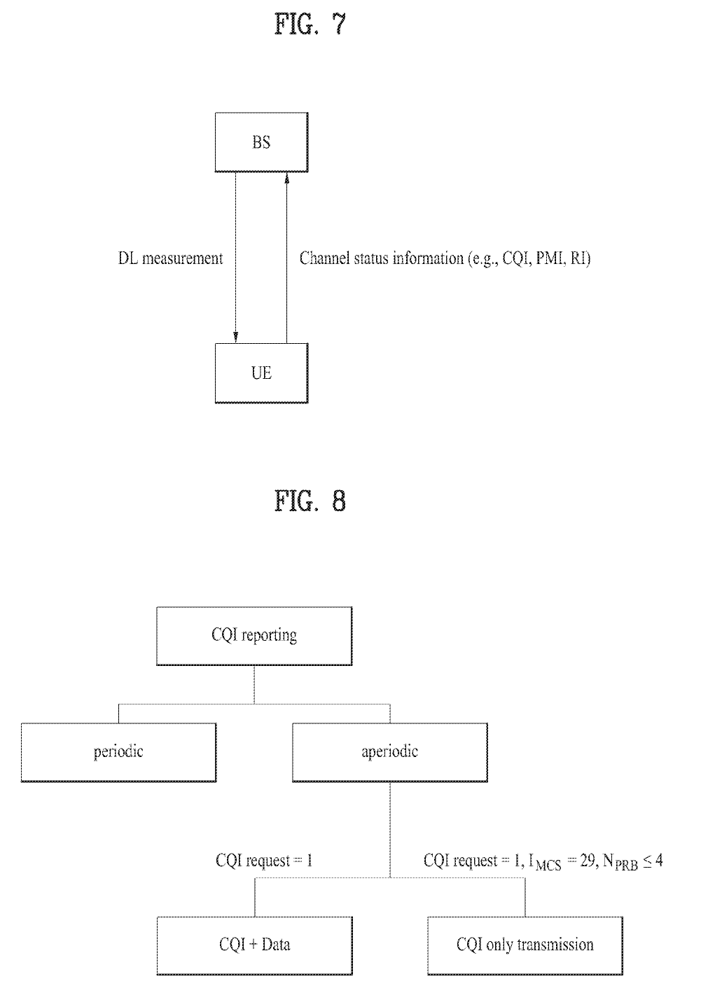

FIG. 7 illustrates an example of a concept for channel status information generation and transmission.

Referring to FIG. 7, a UE measures downlink quality and reports channel state information to an eNB. The eNB performs downlink scheduling (UE selection, resource allocation, etc.) according to the reported channel state information. The channel state information includes at least one selected from the group consisting of CQI, PMI, and RI. The CQI can be generated in various ways. For example, it may be able to quantize channel state (or spectrum efficiency), calculate SINR, or use MCS (modulation and coding scheme) for a state to which a channel is actually applied to generate the CQI.

FIG. 8 illustrates an example of a CQI report scheme of LTE according to a related art.

Referring to FIG. 8, CQI report can be classified into a periodic report and an aperiodic report. The periodic CQI report means that a UE reports channel quality at a determined timing without any separate signaling. On the contrary, the aperiodic CQI report means that a network asks a UE to report CQI via explicit signaling according to the necessity of the network. If the aperiodic CQI report is necessary, the network signals an uplink scheduling grant to the UE using a DCI format 0. If a CQI request value of the DCI format 0 corresponds to 1, the UE performs the aperiodic CQI report. The aperiodic CQI report (i.e., CQI request=1) is divided into a CQI only (transmission) mode and a CQI+data (transmission) mode. If the CQI request value corresponds to 1, an MCS index (IMCS) corresponds to 29, and the number of allocated PRBs is equal to or less than 4 (NPRB≦4), the UE comprehends the signaling as the CQI only mode. Otherwise, the UE comprehends the signaling as the CQI+data mode. In case of the CQI only mode, the UE transmits channel state information only via PUSCH without any data (i.e., UL-SCH transport block). On the contrary, in case of the CQI+data mode, the UE transmits channel state information and data together via PUSCH. The CQI only mode can be referred to as a feedback only mode in general and the CQI+data mode can be referred to as a feedback+data mode. The channel state information includes at least one selected from the group consisting of CQI, PMI, and RI.

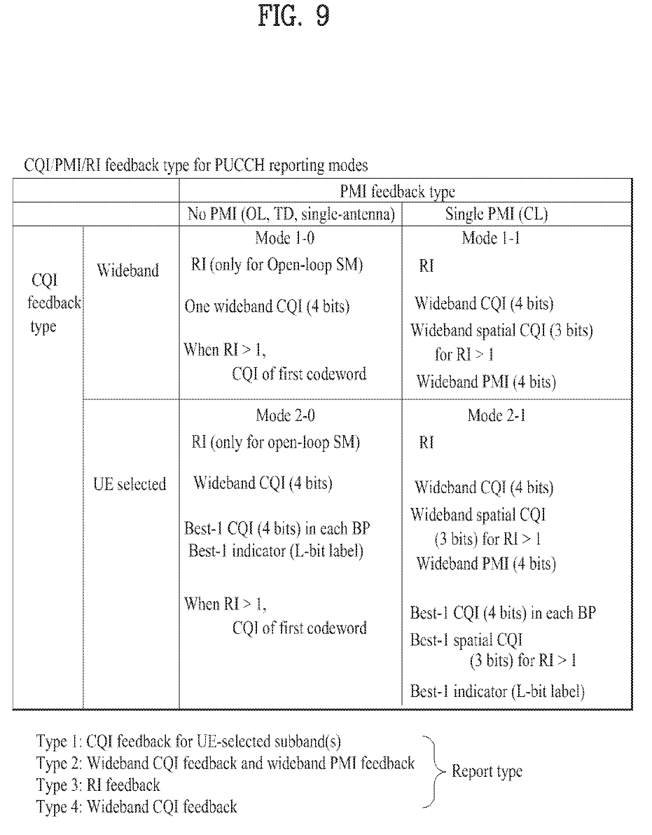

A periodic CSI reporting procedure of legacy LTE is explained with reference to FIG. 9 in the following.

FIG. 9 illustrates CSI report transmitted on PUCCH. Referring to FIG. 9, a UE periodically feedback CQI, PMI, and/or RI on PUCCH according to a PUCCH reporting mode. Information (e.g., period, offset) for periodically reporting CSI is semi-statically configured through higher layer.
Wideband Feedback
Mode 1-0 description:
In case of a subframe in which RI is reported (transmission mode 3 only):
A UE determines RI by assuming transmission on a subband set S.
A UE reports PUCCH reporting type 3 consisting of single RI.
In case of a subframe in which CQI is reported:
   A UE reports PUCCH reporting type 4 consisting of single wideband CQI value. The wideband CQI value is calculated under an assumption of transmission transmitted on a subband set S. A wideband CQI indicates channel quality for a first codeword even when RI is greater than 1.
In case of a transmission mode 3, CQI is calculated based on a lastly reported periodic RI. Otherwise, CQI is calculated based on rank 1.
Mode 1-1 description:
In case of a subframe in which RI is reported (transmission modes 4 and 8 only):
A UE determines RI by assuming transmission on a subband set S.
A UE reports PUCCH reporting type 3 consisting of single RI.
In case of a subframe in which CQI/PMI is reported:
   A single precoding matrix is selected from a codebook subset by assuming transmission on subband set S.
A UE reports PUCCH reporting type 2 consisting of following values at each of continuous reporting opportunities:
   Single wideband CQI value which is calculated under assumption that single precoding matrix is used on the entire subbands and subband set S.
Selected single precoding matrix indicator (wideband PMI).
RI>1 is satisfied, 3-bit wideband spatial difference CQI
In case of transmission modes 4 and 8, PMI and CQI are calculated based on a lastly reported periodic RI. Otherwise, PMI and CQI are calculated based on rank 1.
UE-selected subband feedback
Mode 2-0 description:
In case of a subframe in which RI is reported (transmission mode 3 only):
A UE determines RI by assuming transmission on a subband set S.
A UE reports PUCCH reporting type 3 consisting of single RI.
In case of a subframe in which CQI is reported:
   A UE reports PUCCH reporting type 4 consisting of single wideband CQI value at each of continuous reporting opportunities. The wideband CQI value is calculated under an assumption of transmission transmitted on a subband set S. A wideband CQI indicates channel quality for a first codeword even when RI is greater than 1.
In case of a transmission mode 3, CQI is calculated based on a lastly reported periodic RI. Otherwise, CQI is calculated based on rank 1
In case of a subframe in which CQI for selected subband is reported:
   A UE selects a subband preferred by the UE from among Nj subband set in J band part.
   A UE reports PUCCH reporting type 1 consisting of one CQI value to which transmission on the subband selected in the previous step is reflected only and transmits L-bit label indicating a subband preferred by the UE. PUCCH reporting type 1 for each band part is alternately reported in a next reporting opportunity.
In case of transmission mode 3, selection of preferred subband and CQI value are calculated based on a lastly reported periodic RI. Otherwise, CQI is calculated based on rank 1.
Mode 2-1 description:
In case of a subframe in which RI is reported (transmission modes 4 and 8 only):
A UE determines RI by assuming transmission on a subband set S.
A UE reports PUCCH reporting type 3 consisting of single RI.
In case of a subframe in which wideband CQI/PMI is reported:
   Single precoding matrix is selected from codebook subset by assuming transmission on subband set S.
A UE reports PUCCH reporting type 2 consisting of following values at each of continuous reporting opportunities.
   Wideband CQI value which is calculated under assumption that transmission on entire subbands and subband S use single precoding matrix.
Selected single precoding matrix indicator (wideband PMI).
If RI>1 is satisfied, additional 3-bit wideband spatial difference CQI.
In case of transmission modes 4 and 8, PMI and CQI are calculated based on a lastly reported periodic RI. Otherwise, PMI and CQI are calculated based on rank 1.
In case of a subframe in which CQI for selected subband is reported:
A UE selects a subband preferred by the UE from among Nj subband set in J band part.
A UE reports PUCCH reporting type 1 according to a band part including following values at each of continuous reporting period:
CQI value for code 0 reflecting transmission on a subband only selected from the previous step, and L-bit label indicating a preferred subband
If RI>1 is satisfied, additional 3-bit subband spatial difference CQI value for codeword 1 offset level
Codeword 1 offset level=subband CQI index for codeword 0 ? subband CQI index for codeword 1
Use of most recently reported single precoding matrix is assumed in transmission on the entire subbands and subband set S.

In case of transmission modes 4 and 8, subband selection and CQI are calculated based on a lastly reported periodic RI. Otherwise, subband selection and CQI are calculated based on rank 1.

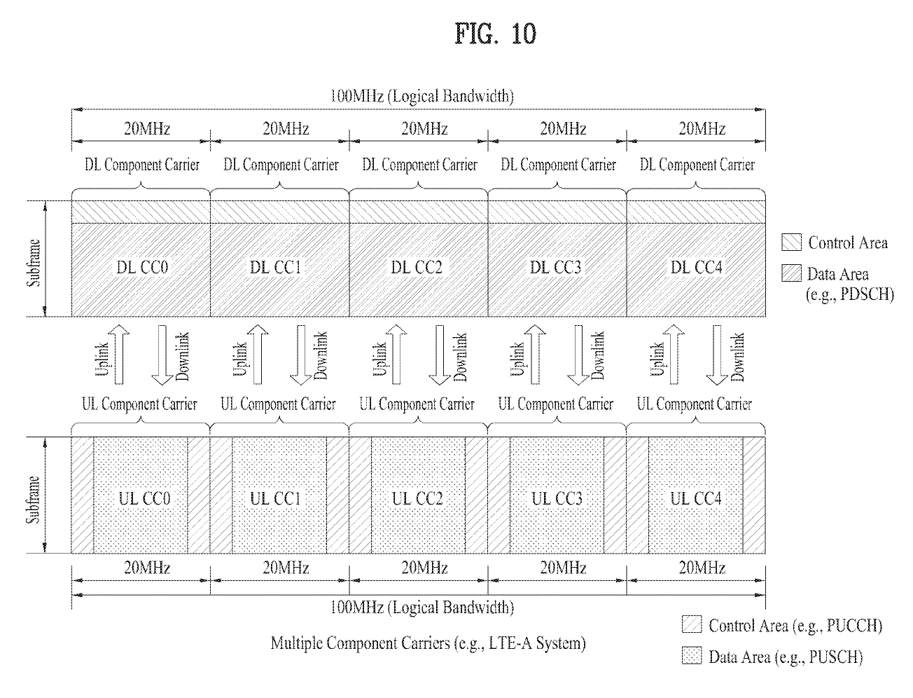

FIG. 10 illustrates carrier aggregation (CA) communication system.

Referring to FIG. 10, a plurality of UL/DL component carriers (CCs) can be aggregated to support a wider UL/DL bandwidth. The CCs may be contiguous or non-contiguous in the frequency domain. Bandwidths of the CCs can be independently determined. Asymmetrical CA in which the number of UL CCs is different from the number of DL CCs can be implemented. Control information may be transmitted/received only through a specific CC. This specific CC may be referred to as a primary CC and other CCs may be referred to as secondary CCs. For example, when cross-carrier scheduling (or cross-CC scheduling) is applied, a PDCCH for downlink allocation can be transmitted on DL CC #0 and a PDSCH corresponding thereto can be transmitted on DL CC #2. The term “component carrier” may be replaced by other equivalent terms (e.g. “carrier”, “cell”, etc.).

For cross-CC scheduling, a carrier indicator field (CIF) is used. Presence or absence of the CIF in a PDCCH can be determined by higher layer signaling (e.g. RRC signaling) semi-statically and UE-specifically (or UE group-specifically). The baseline of PDCCH transmission is summarized as follows.
CIF disabled: a PDCCH on a DL CC is used to allocate a PDSCH resource on the same DL CC or a PUSCH resource on a linked UL CC.
No CIF
CIF enabled: a PDCCH on a DL CC can be used to allocate a PDSCH or PUSCH resource on a specific DL/UL CC from among a plurality of aggregated DL/UL CCs using the CIF.
LTE DCI format extended to have CIF
CIF corresponds to a fixed x-bit field (e.g. x=3) (when CIF is set)
CIF position is fixed irrespective of DIC format size (when CIF is set)

When the CIF is present, the BS may allocate a monitoring DL CC (set) to reduce BD complexity of the UE. For PDSCH/PUSCH scheduling, the UE may detect/decode a PDCCH only on the corresponding DL CCs. The BS may transmit the PDCCH only through the monitoring DL CC (set). The monitoring DL CC set may be set UE-specifically, UE-group-specifically or cell-specifically.

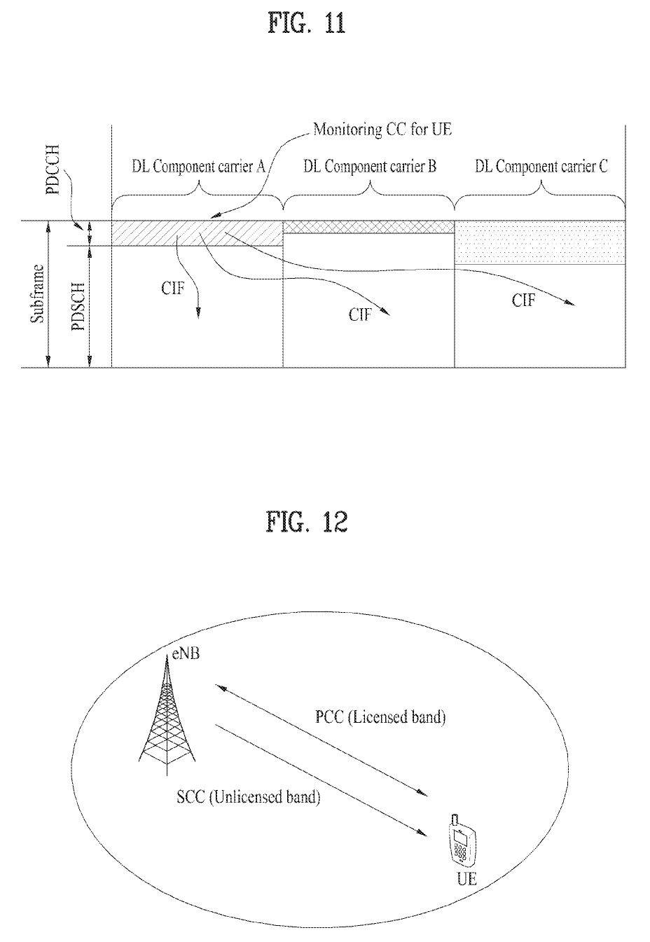

FIG. 11 illustrates scheduling when a plurality of carriers is aggregated. It is assumed that 3 DL CCs are aggregated and DL CC A is set to a PDCCH CC. DL CC A˜C may be referred to as a serving CC, serving carrier, serving cell, etc. When the CIF is disabled, each DL CC can transmit only a PDCCH that schedules a PDSCH corresponding to the DL CC without a CIF according to LTE PDCCH rule (non-cross-CC scheduling). When the CIF is enabled through UE-specific (or UE-group-specific or cell-specific) higher layer signaling, a specific CC (e.g. DL CC A) can transmit not only the PDCCH that schedules the PDSCH of DL CC A but also PDCCHs that schedule PDSCHs of other DL CCs using the CIF (cross-scheduling). A PDCCH is not transmitted on DL CC B and DL CC C.

### Embodiment: Signal Transmission and Reception in LTE-U

As more communication devices require greater communication capacity, efficient utilization of limited frequency bands is becoming an increasingly important requirement in future wireless communication systems. Basically, a frequency spectrum is divided into a licensed band and an unlicensed band. The license band includes frequency bands occupied for a specific usage. For example, the license band includes a frequency band assigned by government for cellular communications (e.g., LTE frequency bands). The unlicensed band is a frequency band occupied for public use and is also referred to as a license-free band. The unlicensed band can be used by anyone without permission or declaration if it meets conditions of radio wave regulations. The unlicensed band is distributed or designated for the use of anyone at a close range, such as within a specific area or building, in an output range that does not interfere communication of other radio stations, and is widely used for wireless remote control, wireless power transmission, wireless LAN (WiFi), and the like.

A cellular communication system such as LTE system also considers a method of utilizing an unlicensed band (e.g., 2.4 GHz, 5 GHz band) used by a legacy WiFi system for traffic offloading. Basically, the unlicensed band is assumed to perform wireless transmission and reception through contention between communication nodes. Therefore, it is required for each communication node to perform channel sensing (CS) before a signal is transmitted and check that a different communication node does not transmit a signal. This is called CCA (Clear Channel Assessment). It may be necessary for a base station or a UE of an LTE system to perform the CCA to transmit a signal in an unlicensed. For clarity, an unlicensed band used in the LTE-A system is referred to as an LTE-U band. In addition, when a base station or a UE of an LTE-A system transmits a signal, other communication nodes such as WiFi and the like should perform the CCA to prevent interference. For example, according to the WiFi standard (801.11ac), a CCA threshold is regulated by −62 dBm for a non-WiFi signal and is regulated by −82 dBm for a WiFi signal. Therefore, when a signal other than WiFi is received with power equal to or greater than −62 dBm, an STA (Station)/AP (Access Point) does not transmit a signal in order not to cause interference. In WiFi system, if the STA/AP does not detect a signal equal to or greater than the CCA threshold for more than 4 us, the STA/AP performs the CCA and may be then able to perform signal transmission.

FIG. 12 illustrates carrier aggregation of a licensed band and an unlicensed band. Referring to FIG. 12, a base station can transmit a signal to a UE or a UE can transmit a signal to a base station under a carrier aggregation situation of a license band (hereinafter, LTE-A band) and an unlicensed band (hereinafter, LTE-U band). In this case, a center subcarrier or a frequency resource of the license band is interpreted as a PCC or a PCell, and a center subcarrier or a frequency resource of the unlicensed band can be interpreted as an SCC or a SCell.

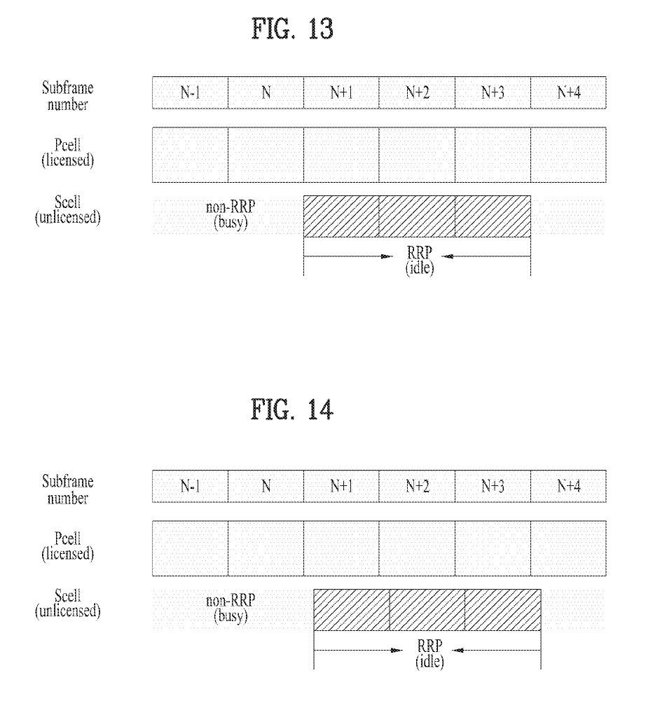

FIGS. 13 and 14 illustrate a method of occupying a resource in an unlicensed band. In order to perform communication between a base station and a UE in an LTE-U band, it is necessary to occupy/secure the band for a specific time period through competition with other communication systems (e.g., WiFi) not associated with LTE-A. For clarity, a time period occupied/secured for cellular communication in the LTE-U band is called RRP (Reserved Resource Period). There exist several methods for securing the RRP. As an example, it may transmit a specific reservation signal during the RRP to make other communication system devices such as WiFi and the like recognize that a radio channel is busy. For example, a base station may consistently transmit an RS and a data signal within the RRP to make a signal equal to or greater than a specific power level to be seamlessly transmitted during the RRP. If the base station determines the RRP to be occupied on the LTE-U band in advance, the base station informs the UE of the RRP in advance to enable the UE to maintain a communication transmission/reception link during the RRP indicated by the base station. As a method of informing the UE of information on the RRP, the base station can forward the information on the RRP to the UE through a different CC (e.g., LTE-A band) which is connected in a form of carrier aggregation. RRP for uplink transmission can be indicated by the base station or can be checked in a subframe unit by checking a channel state before the UE transmits a signal.

As an example, it is able to configure RRP consisting of M (>=1) number of consecutive SFs. Unlikely, one RRP can also be configured by a set of discontinuous SFs (not depicted). In this case, a base station can inform a UE of a value of the M and M number of SF usages in advance through higher layer (e.g., RRC or MAC) signaling (using PCell) or a physical control/data channel. A start point of the RRP can be periodically configured via higher layer (e.g., RRC or MAC) signaling. And, when an SF #n is configured as the start point of the RRP, the start point of the RRP can be designated in the SF #n or an SF #(n-k) via physical layer signaling (e.g., (E)PDCCH). In this case, K is a positive integer (e.g., 4).

The RRP can be configured in a manner that an SF boundary and an SF number/index are matched with a Pcell (hereinafter, aligned-RRP) (FIG. 13) or can be configured in a manner that the SF boundary or the SF number/index is not matched with the Pcell (hereinafter, floating-RRP) (FIG. 14). In the present invention, if an SF boundary is matched between cells, it may indicate that an interval between SF boundaries of two cells different from each other is equal to or less than a specific time (e.g., CP length, or X us (X≧0)). And, in the preset invention, the PCell may correspond to a reference cell for determining an SF (and/or symbol) boundary of an UCell in terms of time (and/or frequency) synchronization.

As a different operation example of an unlicensed band operating with a contention-based random access scheme, a base station can perform carrier sensing prior to data transmission and reception. The base station checks whether a current channel state of a SCell is busy or idle. If it is determined as idle, the base station transmits a scheduling grant (e.g., (E)PDCCH) to the UE through PCell (LTE-A band) or SCell (LTE-U band) and may be then able to attempt to transmit and receive data in the SCell.

In the following, a method of constructing and reporting CSI feedback in a cell/carrier in which available resource sections are aperiodically or discontinuously secured/configured is proposed. The present invention can be applied to an LTE-U system which operates opportunistically on an unlicensed band based on carrier sensing. For clarity, assume a CA situation between a PCell operating on a legacy license band and a SCell operating with a LTE-U scheme in the following. For clarity, an LTE-U based cell (e.g., SCell) is defined as UCell and a resource period aperiodically secure/configured in the UCell is defined as RRP. A center frequency of the UCell is defined as (DL/UL) UCC. Meanwhile, a cell (e.g., PCell, SCell) operating on the legacy license band is defined as LCell, and a center frequency of the LCell is defined as (DL/UL) LCC.

In the following, a periodic CSI feedback configuration and processing/operation, an aperiodic CSI feedback configuration, and a request/report method appropriated for a CA situation including an RRP-based UCell are explained. For clarity, a case of scheduling the UCell from an identical cell and a case of scheduling the UCell from a different cell (e.g., PCell) are referred to as self-CC scheduling and cross-CC scheduling, respectively.

For clarity of explanation, assume a situation that one license band and one unlicensed band are merged into a UE and a wireless communication is configured to be performed through the same. However, schemes proposed in the present invention can also be applied to a situation that a plurality of license bands and a plurality of unlicensed bands are used by a carrier aggregation technique. And, the schemes of the present invention can also be applied to a case that a signal is transceived between a base station and a UE using an unlicensed band only. In addition, the proposed schemes of the present invention can be extended not only to the 3GPP LTE system but also to systems having other characteristics. In the following, the base station is used as a comprehensive term including a remote radio head (RRH), an eNB, a transmission point (TP), a reception point (RP), a relay, and the like.

(0) Method of Determining CSI Measurement Resource in RRP-Based UCell

In a legacy system, a CSI measurement target resource (e.g., CSI reference resource) can be defined as follows.

1) In case of periodic CSI, a CSI measurement target resource (e.g., CSI reference resource) for CSI feedback, which is configured to be transmitted via an SF #n, can be defined to include an SF #(n−kₘᵢₙ) or can be defined by a (valid) DL SF closest to the SF #(n−kₘᵢₙ) (e.g., kₘᵢₙ=4).

2) In case of aperiodic CSI, a CSI measurement target resource for CSI feedback, which is configured to be transmitted via an SF #n, can be defined by a DL SF in which UG DCI for scheduling (aperiodic CSI requested) PUSCH of the SF #n is transmitted. For clarity, a corresponding DL SF timing can be defined as SF #(n−k_{ulg}). In this case, the k_{ulg} is a positive integer and may have a different value depending on TDD/FDD. Table 4 in the following illustrates k_{ulg} according to UL-DL configuration in TDD. In FDD, the k_{ulg} may correspond to 4.

TABLE 4

| TDD UL/DL | DL subframe number i | | | | | | | | | |
|---|---|---|---|---|---|---|---|---|---|---|
| Configuration | 0 | 1 | 2 | 3 | 4 | 5 | 6 | 7 | 8 | 9 |

| | | | | | | | | |
|---|---|---|---|---|---|---|---|---|
| 0 | 7 | 4 | | | 7 | 4 | | |
| 1 | | 4 | | 6 | | 4 | | 6 |
| 2 | | | 6 | | | | 6 | |
| 3 | 6 | | | | | | 6 | 6 |
| 4 | | | | | | | 6 | 6 |
| 5 | | | | | | | 6 | |
| 6 | 6 | 4 | | | 7 | 4 | | 6 |

Meanwhile, in case of UCell, a carrier sensing result of an unlicensed may vary according to time. As a result, channel quality (e.g., CQI) of the UCell may have a difference between RRPs.

In consideration of this, a CSI measurement resource in the UCell includes an SF #(n−kₘᵢₙ) in RRP and can be determined by a closest DL SF prior to the SF #(n−kₘᵢₙ). It may apply 1) only or apply 1)+2-1) or 1)+2-2).

1) RRP to which SF #(n−kₘᵢₙ) belongs thereto

2-1) When there is no RRP to which SF #(n−kₘᵢₙ) belongs thereto, if an interval between 2 RRPs adjacent to the front and the back of the SF #(n−kₘᵢₙ) is equal to or less than a specific value (e.g., N1 number of SFs) (N1 is a positive integer), RRP positioned ahead of the SF #(n−kₘᵢₙ)

2-2) When there is no RRP to which SF #(n−kₘᵢₙ) belongs thereto, if an interval between previous RRP closest to the SF #(n−kₘᵢₙ) and the SF #(n−kₘᵢₙ) is equal to or less than a specific value (e.g., N2 number of SFs), previous RRP closest to the SF #(n−kₘᵢₙ).

In relation to this, CSI feedback transmission transmitted in the SF #n can be omitted (e.g., dropped). In a-1), RRP may correspond to RRP to which the SF #(n−kₘᵢₙ) actually belongs thereto or RRP determined according to 2-1) to 2-2). a-2) indicates a case that there is no RRP to which the SF #(n−kₘᵢₙ) actually belongs thereto.

a-1) A case that SF #(n−kₘᵢₙ) is included within RRP and DL SF does not exist before the SF #(n−kₘᵢₙ)

a-2) A case that SF #(n−kₘᵢₙ) does not belong to RRP

b-1) When there is no RRP to which SF #(n−kₘᵢₙ) belongs thereto, a case that an interval between two RRPs adjacent to the front and the back of the SF #(n−kₘᵢₙ) exceeds a specific value (e.g., N1 number of SFs).

b-2) When there is no RRP to which SF #(n−kₘᵢₙ) belongs thereto, a case that an interval between previous RRP closest to the SF #(n−kₘᵢₙ) and the SF #(n−kₘᵢₙ) exceeds a specific value (e.g., N1 number of SFs)

As a different method, a CSI measurement resource in the UCell includes an SF #(n−kₘᵢₙ) in a next RRP and can be determined by a closest DL SF prior to the SF #(n−kₘᵢₙ). It may apply 3) only or apply 3)+4-1) or 3)+4-2).

3) RRP to which SF #n belongs thereto

4-1) When there is no RRP to which SF #n belongs thereto, if an interval between 2 RRPs adjacent to the front and the back of the SF #n is equal to or less than a specific value (e.g., N3 number of SFs) (N3 is a positive integer), RRP positioned ahead of the SF #n.

4-2) When there is no RRP to which SF #n belongs thereto, if an interval between previous RRP closest to the SF #n and the SF #n is equal to or less than a specific value (e.g., N4 number of SFs) (N4 is a positive integer), previous RRP closest to the SF #n.

In relation to this, CSI feedback transmission transmitted in the SF #n can be omitted (e.g., dropped). In c-1), RRP may correspond to RRP to which the SF #n actually belongs thereto or RRP determined according to 4-1) to 4-2). c-2) indicates a case that there is no RRP to which the SF #n actually belongs thereto.

c-1) A case that SF #(n−kₘᵢₙ) is included within RRP and DL SF does not exist before the SF #(n−kₘᵢₙ)

c-2) A case that SF #n does not belong to RRP

d-1) When there is no RRP to which SF #n belongs thereto, a case that an interval between two RRPs adjacent to the front and the back of the SF #n exceeds a specific value (e.g., N3 number of SFs).

d-2) When there is no RRP to which the SF #n belongs thereto, a case that an interval between previous RRP closest to the SF #n and the SF #n exceeds a specific value (e.g., N4 number of SFs)

And, in case of aperiodic CSI, a CSI measurement resource in the UCell includes an SF #(n−k_{ulg}) within RRP determined as follows and can be determined by a closest DL SF prior to the SF #(n−k_{ulg}). It may apply 5) only or apply 5)+6-1) or 5)+6-2).

5) RRP to which SF #(n−k_{ulg}) belongs thereto

6-1) When there is no RRP to which SF #(n−k_{ulg}) belongs thereto, if an interval between 2 RRPs adjacent to the front and the back of the SF #(n−k_{ulg}) is equal to or less than a specific value (e.g., N1 number of SFs) (N1 is a positive integer), RRP positioned ahead of the SF #(n−k_{ulg}).

6-2) When there is no RRP to which SF #(n−k_{ulg}) belongs thereto, if an interval between previous RRP closest to the SF #(n−k_{ulg}) and the SF #(n−k_{ulg}) is equal to or less than a specific value (e.g., N2 number of SFs) (N2 is a positive integer), previous RRP closest to the SF #(n−k_{ulg}).

In relation to this, CSI feedback transmission transmitted in the SF #n can be omitted (e.g., dropped). In e-1), RRP may correspond to RRP to which the SF #(n−k_{ulg}) actually belongs thereto or RRP determined according to 6-1) to 6-2). e-2) indicates a case that there is no RRP to which the SF #(n−k_{ulg}) actually belongs thereto.

e-1) A case that SF #(n−k_{ulg}) is included within RRP and DL SF does not exist before the SF #(n−k_{ulg})

e-2) A case that SF #(n−k_{ulg}) does not belong to RRP

f-1) When there is no RRP to which SF #(n−k_{ulg}) belongs thereto, a case that an interval between two RRPs adjacent to the front and the back of the SF #(n−k_{ulg}) exceeds a specific value (e.g., N1 number of SFs).

f-2) When there is no RRP to which the SF #(n−k_{ulg}) belongs thereto, a case that an interval between previous RRP closest to the SF #(n−k_{ulg}) and the SF #(n−k_{ulg}) exceeds a specific value (e.g., N1 number of SFs)

As a different method, a CSI measurement resource in the UCell includes an SF #(n−k_{ulg}) in a next RRP and can be determined by a closest DL SF prior to the SF #(n−k_{ulg}). It may apply 7) only or apply 7)+8-1) or 7)+8-2).

7) RRP to which SF #n belongs thereto

8-1) When there is no RRP to which SF #n belongs thereto, if an interval between 2 RRPs adjacent to the front and the back of the SF #n is equal to or less than a specific value (e.g., N3 number of SFs) (N3 is a positive integer), RRP positioned ahead of the SF #n.

8-2) When there is no RRP to which SF #n belongs thereto, if an interval between previous RRP closest to the SF #n and the SF #n is equal to or less than a specific value (e.g., N4 number of SFs) (N4 is a positive integer), previous RRP closest to the SF #n.

In relation to this, CSI feedback transmission transmitted in the SF #n can be omitted (e.g., dropped). In g-1), RRP may correspond to RRP to which the SF #n actually belongs thereto or RRP determined according to 8-1) to 8-2). g-2) indicates a case that there is no RRP to which the SF #n actually belongs thereto.

g-1) A case that SF #(n−k_{ulg}) is included within RRP and DL SF does not exist before the SF #(n−k_{ulg})

g-2) A case that SF #n does not belong to RRP

h-1) When there is no RRP to which SF #n belongs thereto, a case that an interval between two RRPs adjacent to the front and the back of the SF #n exceeds a specific value (e.g., N3 number of SFs).

h-2) When there is no RRP to which the SF #n belongs thereto, a case that an interval between previous RRP closest to the SF #n and the SF #n exceeds a specific value (e.g., N4 number of SFs).

In this case, (in case of periodic CSI), CSI feedback transmission can be omitted. It means that corresponding CSI is excluded in the course of determining one CSI only having highest priority when CSI feedback transmissions for a plurality of cells are collided with each other at the same timing. In other word, when CSI feedback timings for a plurality of cells collide with each other, it may be able to determine/transmit one CSI having the highest priority only among the remaming CSI feedbacks except the CSI feedback which is omitted through application of the aforementioned method. The CSI feedback priority can be determined by applying a CSI reporting type/CSI process index, and a cell index-based protection priority described in the following.

Or, when CSI feedback transmission is omitted, it means that the CSI feedback (e.g., RI/PMI/CQI, etc.) is configured by a lowest rank, a precoding matrix having a lowest index, a CQI index (e.g., OOR (out-of-range) state) indicating lowest channel quality, and the like. In this case (i.e., in the case of periodic CSI), if the CSI feedback has the highest priority in a situation that a plurality of CSI feedback timings collide with each other, transmission of the CSI feedback can be performed. If the transmission of the CSI feedback is set only without a collision with a different CSI feedback timing, the transmission of the CSI feedback can be omitted or abandoned.

(1) Method of Performing Periodic CSI Feedback for RRP-Based UCell

In a legacy CA situation, if periodic CSI transmissions for a plurality of cells collide with each other at the same timing, a UE transmits periodic CSI for a single cell only according to the rules described in the following.

1) All of the remaming CSIs are dropped except CSI having the highest priority according to the predefined protection priority among CSI reporting types (e.g., PUCCH reporting types 3/5/6/2a>2/2b/2c/4>1/1a). If there are a plurality of CSIs having the highest CSI reporting type priority, all of the remaming CSIs are dropped except CSI having a lowest CSI process index.

2) If there still exist a plurality of CSIs having the highest priority after the process of 1) is performed, all of the remaming CSIs are dropped while one CSI for a cell having a lowest cell index (e.g., SerCellIndex) is transmitted only.

Table 5 illustrates PUCCH reporting types (or CSI reporting types) and CSI reported according to the types.

TABLE 5

| PUCCH | | | |
|---|---|---|---|
| Reporting | Reported | PUCCH Reporting | Reported |
| type | Information | type | Information |
| 1 | Sub-band CQI | 2c | Wideband CQI/ |
| | | | first PMI/ |
| | | | second PMI |
| 1a | Sub-band CQI/ | 3 | RI |
| | second PMI | | |
| 2 | Wideband | 4 | Wideband CQI |
| | CQI/PMI | | |
| 2a | Wideband | 5 | RI/first PMI |
| | first PMI | | |
| 2b | Wideband CQI/ | 6 | RI/PTI |
| | second PMI | | |

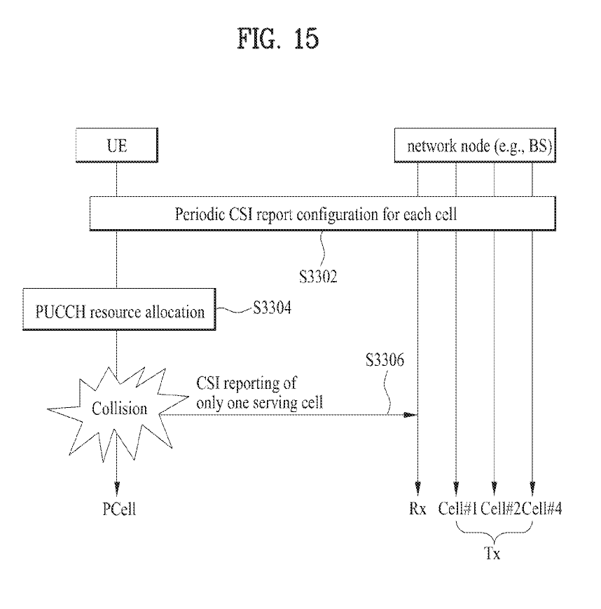

FIG. 15 illustrates a method of performing CSI reporting in a legacy CA situation. The present example assumes a situation that three DL cells are configured. The three cells may indicate activates cells only among all cells configured for a corresponding UE or a configured cell. The configured cell includes a DL PCell and one or more DL SCells. The DL Pcell and the one or more DL SCells are commonly referred to as a serving cell.

Referring to FIG. 15, a UE and a base station establish a configuration for periodic CSI according to a serving cell [S3302]. To this end, the base station transmits configuration information for CSI reporting to the UE. The configuration information for CSI reporting may include various configuration informations (e.g., a PUCCH reporting type, a period, an offset, a band size, etc.). After the configuration information for periodic CSI reporting is configured, the UE performs a PUCCH resource allocation process for CSI reporting according to a PUCCH reporting type/mode in a corresponding subframe according to the CSI report configuration [S3304]. The UE determines whether to perform CSI reporting in the corresponding subframe according to the CSI reporting period and offset configured for each serving cell, and determines whether to allocate a PUCCH resource. The PUCCH resource includes PUCCH formats 2/2a/2b.

The present example assumes a situation that a plurality of CSI reports (i.e., CSI reports of a plurality of serving cells) collide with each other in the same subframe. Each of a plurality of the CSI reports corresponds to a CSI report for a corresponding DL cell. In this case, the UE transmits a CSI report of one serving cell only on PUCCH and drops all CSI reports of other serving cells [S3306]. The dropping of the CSI reports can be performed in the step S3304 (i.e., the channel resource allocation process) or can be performed prior to the step S3304 or after the step S3304 depending on an implementation example. The CSI report of one serving cell can be selected based on the aforementioned CSI reporting type (additionally, the cell index).

Meanwhile, in case of UCell, since resource acquisition depends on a carrier sensing result, RRP(s) can be very irregularly secured. Also, although the RRP is secured, if a corresponding CSI feedback timing collides with a CSI feedback timing for a different cell, since the RRP is dropped by priority, a cell index, or the like, DL scheduling efficiency for the UCell can be degraded.

In consideration of this, when CSI feedback timing for the UCell and CSI feedback timing for a general cell (i.e., LCell) collide with each other in an identical subframe, the present invention proposes to assign higher priority to CSI for the UCell all the time irrespective of the protection priority of the CSI reporting type (and priority between CSI process indexes). When CSI feedback timings for a plurality of UCells collide with each other in the same subframe, it may transmit CSI feedback for one UCell only in consideration of the protection priority among the CSI reporting types, the CSI process index, and the cell index. Or, if a CSI feedback timing for a UCell and a CSI feedback timing for a general SCell collides with each other in the same subframe, the present invention proposes to assign higher priority to CSI for the UCell all the time irrespective of the protection priority of the CSI reporting type (and priority between CSI process indexes). Therefore, if CSI feedback timings for PCell(s), general SCell(s), and UCell(s) collide with each other in the same subframe, CSI feedback for the general SCell(s) is dropped first and CSI feedback for one cell among the PCell(s) and UCell(s) can be transmitted only in consideration of the protection priority among the CSI reporting types, the CSI process index, and the cell index. In this case, the general SCell corresponds to a SCell configured to operate on a license band and the Scell configured not to perform PUCCH (and/or CSS) transmission. A SCell configured to operate on a license band and the Scell configured to perform PUCCH (and/or CSS) transmission can be treated as being identical to a Pcell. In case of the above-mentioned two schemes, it may be able to apply a different scheme depending on the number of carrier aggregated general cells or the number of general SCells. Or, a base station may be able to determine a scheme to be applied in consideration of CSI feedback period relationship between cells and the like.

As a different method, if the CSI feedback timing of the UCell and the CSI feedback timing of the general cell are overlapped with each other and the protection priority of the CSI reporting type (and/or the priority between CSI process indexes) is the same, it may assign the higher priority to the CSI for the UCell. In particular, when the protection priority of the CSI reporting type (and/or the priority between CSI process indexes) is applied, the UCell is not distinguished from the LCell. However, when there are a plurality of CSIs having the highest protection priority, it may assign the higher priority to the CSI of the UCell all the time without additionally applying priority according to a cell index between the CSI of the UCell and the CSI of the LCell. When a plurality of UCell CSIs have the highest protection priority, it may additionally apply a priority according to a cell index to a plurality of the UCell CSIs. Or, if the CSI feedback timing of the UCell and the CSI feedback timing of the general Scell are overlapped with each other and the protection priority of the CSI reporting type (and/or the priority between CSI process indexes) is the same, it may assign the higher priority to the CSI for the UCell. In particular, if transmission timings of Pcell CSI(s), general Scell CSI(s), and UCell CSI(s) collide with each other in the same subframe and have the highest protection priority, priority according to a cell index can be applied to the PCell CSI(s) and the UCell CSI(s) only. In case of the aforementioned two schemes, it may be able to apply a different scheme depending on the number of carrier aggregated general cells or the number of general SCells. Or, a base station may be able to determine a scheme to be applied in consideration of CSI feedback period relationship between cells and the like.

Meanwhile, in order to configure RRP which is dynamically/aperiodically provided via carrier sensing, a specific type of a signal (hereinafter, an RRP-cfg message) can be transmitted to a UE from a base station. Meanwhile, detection performance of the UE for detecting the RRP-cfg message may not be stably maintained depending on a situation. Hence, if the UE fails to detect the RRP-cfg message, inconsistency/ambiguity may occur between the UE and the base station regarding whether or not RRP exists in the UCell. Therefore, if the aforementioned scheme is applied, it may cause inconsistency/ambiguity between the UE and the base station as to a cell for which a reported CSI feedback is used. In order to solve this problem, when the UE reports the CSI feedback, the UE may transmit information indicating a cell together with the CSI feedback. For example, the UE can transmit a cell index together with the CSI feedback to indicate a cell to which CSI is fed back. Transmission of the cell indication information together with the CSI feedback can be applied to both periodic/aperiodic CSI and can be applied only when the UCell is included in a carrier aggregated cell. And, as a method of assigning a high priority to CSI for the UCell, it may assign a higher priority to the UCell compared to a general cell or a general SCell in a specific condition (e.g., channel quality (e.g., CQI) of the UCell (RRP) is equal to or greater than a specific threshold). Hence, the UE may select and report appropriate CSI feedback (of a cell) according to a specific condition.

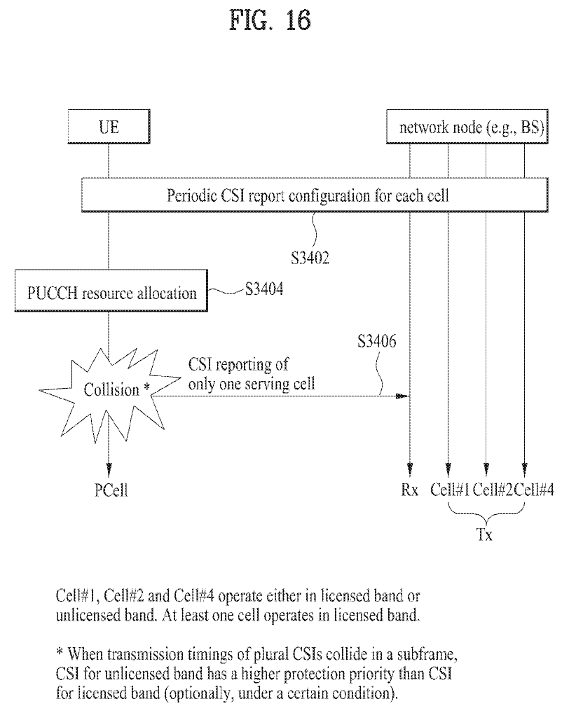

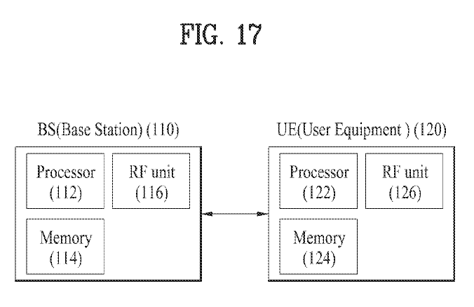

FIG. 16 illustrates a method of reporting CSI according to one embodiment of the present invention. Basically, a situation of FIG. 16 is similar to the situation of FIG. 15. Unlike the situation of FIG. 15, a cell (i.e., LCell) of a licensed band and a cell (i.e., UCell) on an unlicensed band are aggregated with each other between a base station and a UE in the situation of FIG. 16.

Referring to FIG. 16, the UE and the base station establish a configuration for periodic CSI reporting according to each serving cell [S3402]. To this end, the base station transmits configuration information for CSI reporting to the UE. The configuration information for CSI reporting can include various configuration informations (e.g., PUCCH reporting type, a period, an offset, a band size, etc.). After the configuration information for periodic CSI reporting is configured, the UE performs a PUCCH resource allocation process for CSI reporting according to the PUCCH reporting type/mode in a corresponding subframe according to the CSI report configuration [S3404]. The UE determines whether to perform CSI reporting in the corresponding subframe according to the CSI reporting period and offset which are configured according to each serving cell and determines whether to allocate a PUCCH resource. The PUCCH resource includes PUCCH formats 2/2a/2b.

The present example assumes a situation that a plurality of CSI reports (i.e., CSI reports of a plurality of serving cells) collide with each other in the same subframe. Each of a plurality of the CSI reports corresponds to a CSI report for a corresponding DL cell. In this case, the UE transmits a CSI report of one serving cell only on PUCCH and drops all CSI reports of other serving cells [S3406]. The dropping of the CSI reports can be performed in the step S3404 (i.e., the channel resource allocation process) or can be performed prior to the step S3404 or after the step S3404 depending on an implementation example.

The CSI report of one serving cell can be selected based on the aforementioned CSI reporting type (additionally, the cell index). Yet, if transmission timings of LCell CSIs collide only, it may be able to select one CSI using a legacy scheme as it is. However, if transmission timings of the LCell(s) and transmission timings of the UCell CSI(s) collide with each other, it may assign a higher priority to the UCell CSI(s) compared to the LCell CSI(s) in the course of selecting one CSI. Assigning the higher priority to the UCell CSI(s) can be performed using the aforementioned various proposed schemes. Assigning the higher priority to the UCell CSI(s) can be performed only when a specific condition (e.g., channel quality is equal to or greater than a threshold) is satisfied.

(2) Method of Performing Aperiodic CSI Feedback for RRP-Based UCell

In a legacy system, in order for a base station to request aperiodic CSI transmission to a UE, the base station always transmits a UG (UL grant) DCI to allocate a PUSCH resource and the UE transmits CSI using the allocated PUSCH resource. Meanwhile, it is highly probable that RRP in UCell is irregularly provided with limited duration. If aperiodic CSI transmission accompanied with the UG DCI is requested each time to perform DL scheduling on the RRP having the aforementioned characteristics, it is not preferable in terms of overhead.

Hence, the present invention propose to request the aperiodic CSI transmission through a specific DCI instead of the UG DCI and transmit CSI feedback corresponding to the aperiodic CSI transmission using a UL resource configured by the upper layer in a state that the UL resources used for the aperiodic CSI transmission is configured in advance (on a specific LCell or UCell) via higher layer signaling layer (e.g., RRC). In this case, the UL resource configured by the upper layer may have such a form as a PUSCH resource (e.g., RB index) or a PUCCH resource (e.g., a format 3 resource index). If the UL resource has the PUSCH format, it may additionally configure an MCS index for PUSCH transmission and DMRS information. In this case, a specific DCI includes a DG (DL grant) DCI (for scheduling UCell). In addition, the specific DCI may correspond to a DCI of a structure similar to a legacy DCI format 3/3A. For example, it may indicate whether to request the aperiodic CSI according to a bit value in a state that each bit of one DCI is configured for the usage of requesting aperiodic CSI transmission for an individual UE. If aperiodic CSI transmission is requested via specific DCI transmission in an SF #n, CSI feedback includes an SF #(n+kₘᵢₙ) and can be transmitted via a closest UL SF (if the UL resource is set on UCell, within RRP). Meanwhile, if the aperiodic CSI transmission is requested through the UG DCI, aperiodic CSI feedback can be transmitted using a PUSCH resource allocated from the UG DCI.

Meanwhile, when the aperiodic CSI is transmitted through the UL resource (hereinafter, a-CSI container) configured by the higher layer, if a different UCI (e.g., HARQ-ACK, periodic CSI, scheduling request) is requested in a state that there is no PUSCH transmission, 1) it may transmit both the aperiodic CSI and the different UCI using the a-CSI container, or 2) it may transmit the aperiodic CSI and the different UCI using the a-CSI container and a corresponding PUCCH resource, respectively. In case of the aforementioned two schemes, it may be able to adaptively apply a different scheme according to whether or not it is permitted to transmit PUCCH and PUSCH at the same time, a size of the a-CSI container (e.g., number of RBs), a UCI size (e.g., number of bits), and the like. Or, a base station may configure a scheme to be applied in consideration of UCI transmission capability and the like.

If different UCI feedback transmission is required and there exists PUSCH transmission in a situation identical to the aforementioned situation, 1) both the aperiodic CSI and the different UCI are transmitted using a scheduled PUSCH or, 2) it may transmit the aperiodic CSI and the different UCI using the a-CSI container and the scheduled PUSCH, respectively. Similarly, it may be able to adaptively apply a different scheme according to whether or not it is permitted to transmit PUCCH and PUSCH at the same time, a size of the PUSCH and/or the a-CSI container, a UCI size, and the like. Or, a base station may configure a scheme to be applied in consideration of UCI transmission capability and the like.

FIG. 17 illustrates a BS and a UE of a wireless communication system, which are applicable to embodiments of the present invention.

Referring to FIG. 17, the wireless communication system includes a BS 110 and a UE 120. When the wireless communication system includes a relay, the BS or UE can be replaced by the relay.

The BS 110 includes a processor 112, a memory 114 and a radio frequency (RF) unit 116. The processor 112 may be configured to implement the procedures and/or methods proposed by the present invention. The memory 114 is connected to the processor 112 and stores information related to operations of the processor 112. The RF unit 116 is connected to the processor 112 and transmits and/or receives an RF signal. The UE 120 includes a processor 122, a memory 124 and an RF unit 126. The processor 122 may be configured to implement the procedures and/or methods proposed by the present invention. The memory 124 is connected to the processor 122 and stores information related to operations of the processor 122. The RF unit 126 is connected to the processor 122 and transmits and/or receives an RF signal.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It will be obvious to those skilled in the art that claims that are not explicitly cited in each other in the appended claims may be presented in combination as an embodiment of the present invention or included as a new claim by a subsequent amendment after the application is filed.

In the embodiments of the present invention, a description is made centering on a data transmission and reception relationship among a BS, a relay, and an MS. In some cases, a specific operation described as performed by the BS may be performed by an upper node of the BS. Namely, it is apparent that, in a network comprised of a plurality of network nodes including a BS, various operations performed for communication with an MS may be performed by the BS, or network nodes other than the BS. The term ‘BS’ may be replaced with the term ‘fixed station’, ‘Node B’, ‘enhanced Node B (eNode B or eNB)’, ‘access point’, etc. The term ‘UE’ may be replaced with the term ‘Mobile Station (MS)’, ‘Mobile Subscriber Station (MSS)’, ‘mobile terminal’, etc.

The embodiments of the present invention may be achieved by various means, for example, hardware, firmware, software, or a combination thereof. In a hardware configuration, the methods according to the embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present invention may be implemented in the form of a module, a procedure, a function, etc. For example, software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

The embodiments of the present invention mentioned in the foregoing description may be applicable to various kinds of mobile communication systems.

What is claimed is:

1. A method of reporting a channel state, which is reported by a user equipment in a wireless communication system, comprising the steps of:
setting a plurality of cells for performing communication with a base station;
receiving CSI configuration information on each cell from the base station, wherein the CSI configuration information comprises a period for periodic CSI reporting and offset information; and
if periodic transmission timings of a plurality of CSIs collide with each other in a subframe #n, transmitting one CSI only among a plurality of the CSIs,
wherein if cells corresponding to a plurality of the CSIs correspond to all licensed band cells, the one CSI is firstly selected using a priority according to a CSI reporting type and wherein if the cells corresponding to a plurality of the CSIs comprise both a licensed band cell and an unlicensed band cell, the one CSI is selected from CSI corresponding to the unlicensed band cell irrespective of the CSI reporting type.

2. The method of claim 1, wherein if the cells corresponding to a plurality of the CSIs comprise a plurality of unlicensed band cells, the one CSI is selected from a plurality of CSIs corresponding to a plurality of the unlicensed band cells using a priority according to the CSI reporting type.

3. The method of claim 1, wherein if the one CSI is contained in the licensed band cell, transmission of the one CSI does not involve transmission of cell indication information on the licensed band cell and wherein if the one CSI is contained in the unlicensed band cell, the transmission of the one CSI involves transmission of cell indication information on the unlicensed band cell.

4. The method of claim 1, wherein the one CSI is transmitted on PUCCH (physical uplink control channel) of the licensed band cell.

5. A user equipment configured to report a channel state in a wireless communication system, comprising:
an RF (radio frequency) module; and
a processor, the processor configured to set a plurality of cells for performing communication with a base station, the processor configured to receive CSI configuration information on each cell from the base station, wherein the CSI configuration information comprises a period for periodic CSI reporting and offset information, the processor, if periodic transmission timings of a plurality of CSIs collide with each other in a subframe #n, configured to transmit one CSI only among a plurality of the CSIs,
wherein if cells corresponding to a plurality of the CSIs correspond to all licensed band cells, the one CSI is firstly selected using a priority according to a CSI reporting type and wherein if the cells corresponding to a plurality of the CSIs comprise both a licensed band cell and an unlicensed band cell, the one CSI is selected from CSI corresponding to the unlicensed band cell irrespective of the CSI reporting type.

6. The user equipment of claim 5, wherein if the cells corresponding to a plurality of the CSIs comprise a plurality of unlicensed band cells, the one CSI is selected from a plurality of CSIs corresponding to a plurality of the unlicensed band cells using a priority according to the CSI reporting type.

7. The user equipment of claim 5, wherein if the one CSI is contained in the licensed band cell, transmission of the one CSI does not involve transmission of cell indication information on the licensed band cell and wherein if the one CSI is contained in the unlicensed band cell, the transmission of the one CSI involves transmission of cell indication information on the unlicensed band cell.

8. The user equipment of claim 5, wherein the one CSI is transmitted on PUCCH (physical uplink control channel) of the licensed band cell.
